(19) United States
(12) Patent Application Publication
(10) Pub. No.: US 2022/0370174 A1
(43) Pub. Date: Nov. 24, 2022

(54) ORTHODONTIC APPLIANCES

(71) Applicant: Braces On Demand Inc., Hicksville, NY (US)

(72) Inventors: Thomas Patrick Shannon, Byron Center, MI (US); Colin James Corey, Carlsbad, CA (US); Ammar Ahmed Syed, Unionville (CA)

(21) Appl. No.: 17/743,596

(22) Filed: May 13, 2022

Related U.S. Application Data
(60) Provisional application No. 63/190,130, filed on May 18, 2021.

(51) Int. Cl. A61C 7/16

(52) U.S. Cl. CPC A61C 7/16

(57) ABSTRACT

In some embodiments, apparatuses and methods are provided herein useful to orthodontic appliances. In some embodiments, an orthodontic appliance comprises a body, a facial surface, wherein the facial surface is located on a first side of the body, and a bonding surface, wherein the bonding surface is located on a second side of the body, wherein the bonding surface includes at least one retentive groove, and wherein the at least one retentive groove is nonlinear across the bonding surface.

### TECHNICAL FIELD

This invention relates generally to orthodontics and, more specifically, orthodontic appliances.

### BACKGROUND

Orthodontic clinicians seek to correct malocclusions by use of many different devices, such as braces, retainers, aligners, pallet expanders, positioners, etc. Different types of devices can be used in different circumstances and may have different strengths and weaknesses. One of the more common types of orthodontic appliance is braces. Braces generally comprises brackets, archwires, and ligatures. The brackets are adhered to the patient's teeth and the archwires pass through the brackets (e.g., archwire slots of the brackets) and exert forces upon the brackets. The ligatures secure the archwires in the archwire slots. Brackets include a bonding surface that faces the patient's tooth. Typically, the bonding surface includes features (e.g., indentations) that become at least partially filled with adhesive when the bracket is applied to the patient's tooth. Due to manufacturing constraints, these indentations are linear. While linear indentations can be used to securely adhere brackets to a patient's teeth, the linear nature of the indentations requires clinicians to apply adhesive to the brackets in a specific manner. Because the adhesive must be applied in a specific manner, it is not uncommon for the adhesive to be insufficiently or poorly applied to the bonding surface. Additionally, even if the adhesive is applied properly to the bonding surface of the bracket, the brackets may be able to slide or move with respect to the patient's teeth once bonded due to the linear design of the indentations. Accordingly, a need exists for improved orthodontic appliance designs that allow for adhesive to be more easily applied to the bonding surface and create a more secure bond.

### BRIEF DESCRIPTION OF THE DRAWINGS

Disclosed herein are embodiments of systems, apparatuses, and methods pertaining orthodontic appliances. This description includes drawings, wherein:

FIG. 1 depicts an orthodontic appliance 100 including retentive grooves 108 in a bonding surface 104 of the orthodontic appliance 100, according to some embodiments;

FIGS. 2A and 2B are top and sectional views, respectively, of an orthodontic appliance 200 including retentive grooves 202 in a bonding surface 204 of the orthodontic appliance 200, according to some embodiments;

FIGS. 3A and 3B are top and isometric views, respectively, of an orthodontic appliance 300 including retentive grooves 304 in a bonding surface 302 of the orthodontic appliance 300, according to some embodiments;

FIGS. 4A-4C depict orthodontic appliances 400 including markers 410 in a bonding surface 402 of the orthodontic appliance 400, according to some embodiments;

FIGS. 5A, 5B, and 5C are top, isometric, and sectional views, respectively, of an orthodontic appliance 500 including negatively extruded retentive grooves 502 functioning as markers, according to some embodiments;

FIG. 6 is a block diagram of a system 600 for providing data files associated with orthodontic appliances, according to some embodiments; and

FIG. 7 is a flow chart including example operations for providing data files associated with orthodontic appliances, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

Generally speaking, pursuant to various embodiments, systems, apparatuses and methods are provided herein useful to orthodontic appliances. In some embodiments, an orthodontic appliance comprises a body, a facial surface, wherein the facial surface is located on a first side of the body, and a bonding surface, wherein the bonding surface is located on a second side of the body, wherein the bonding surface includes at least one retentive groove, and wherein the at least one retentive groove is nonlinear across the bonding surface.

As previously discussed, some orthodontic appliances feature a bonding surface that faces the patient's teeth. A clinician applies a bonding agent, such as an adhesive, to the bonding surface of the orthodontic appliance to bond the orthodontic appliance to the patient's tooth. Oftentimes, the bonding surface includes features, such as indentations, to receive the adhesive. These indentations, however, are linear across the bonding surface of the orthodontic appliance. Due to the linear design of the features, it can be difficult to properly apply adhesive to the bonding surface. Additionally, due to the linear design, even if the adhesive is properly applied to the bonding surface, the orthodontic appliances may slide or move with respect to the patient's teeth once bonded.

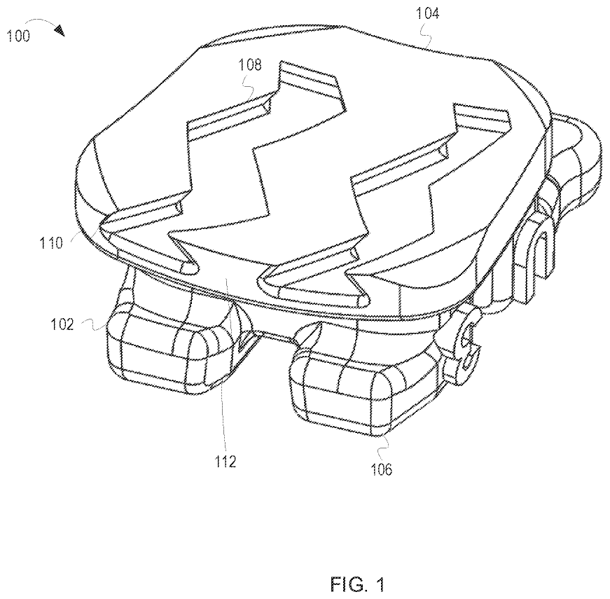

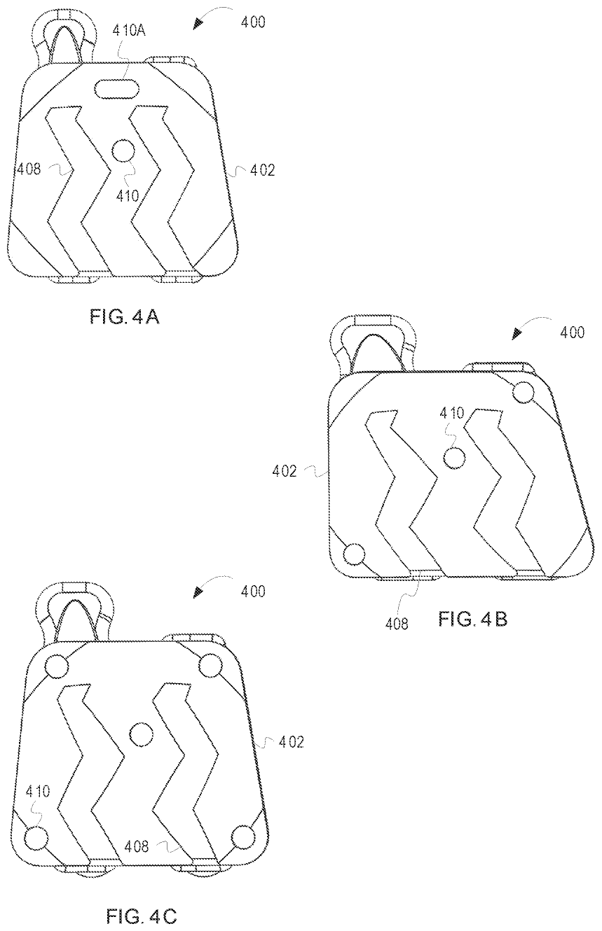

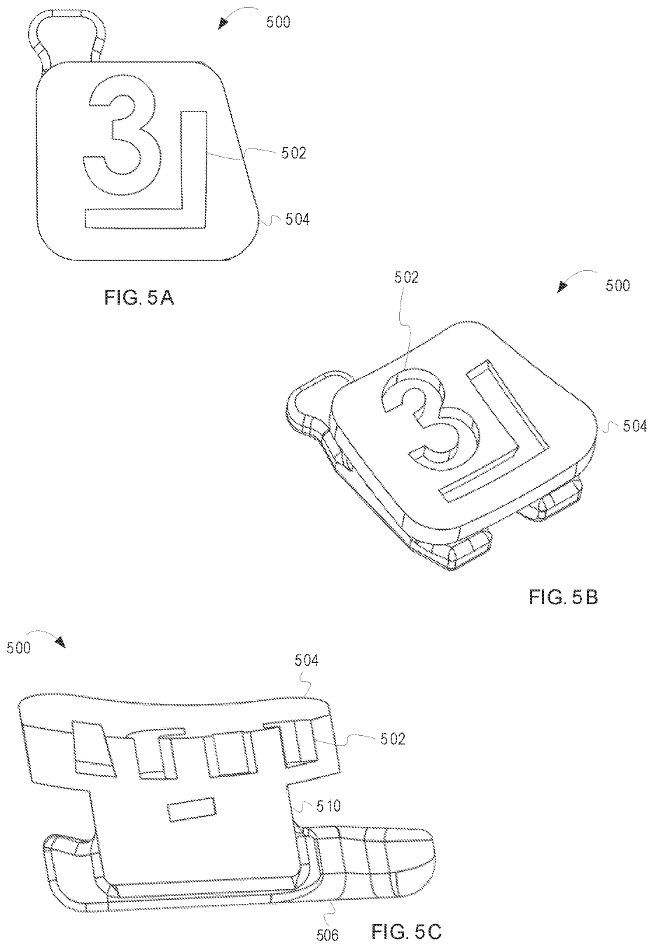

Described herein are orthodontic appliances, orthodontic systems, and methods of manufacture of orthodontic appliances that seek to minimize, if not eliminate, these problems with the current design. In one embodiment, an orthodontic appliance includes a bonding surface. The bonding surface features one or more retentive grooves. The retentive grooves are negatively extruded into a body (e.g., bonding surface) of the orthodontic appliance. At least one of the retentive grooves is nonlinear across the bonding surface. The retentive grooves can be elongated retentive grooves (e.g., like those described with respect to FIGS. 1-3) and/or markers (e.g., those described with respect to FIGS. 4 and 5). In some embodiments, the retentive grooves function as markers indicating positions for the orthodontic appliances in a patient's mouth. The discussion of FIG. 1 provides an overview of an orthodontic appliance featuring negatively extruded retentive grooves.

FIG. 1 depicts an orthodontic appliance 100 including retentive grooves 108 in a bonding surface 104 of the orthodontic appliance 100, according to some embodiments. The retentive grooves 108 depicted in FIG. 1 are elongated retentive grooves. The orthodontic appliance 100 can be any suitable type of orthodontic appliance, such as a bracket, molar tube, buccal tube, Class II Corrector, Class III Corrector, etc. The orthodontic appliance 100 includes a body 102, a facial surface 106, and a bonding surface 104. The facial surface 106 is located on a first side of the orthodontic appliance 100 and the bonding surface 104 is located on a second side of the orthodontic appliance 100. For example, the facial surface 106 and the bonding surface 104 can be opposite one another. The facial surface 106 and/or body 102 can include any desired features, such as archwire slots, hooks, buttons, tiewings, self-ligating features, etc. The retentive grooves are negatively extruded into the body 102 of the orthodontic appliance. For example, the orthodontic appliance 100 can be additively manufactured and the retentive grooves 108 are negatively extruded during the manufacture of the orthodontic appliance 100.

The bonding surface 104 is configured to be bonded to a patient's tooth. For example, the bonding surface 104 can be bonded to the patient's tooth via bonding material. The bonding surface 104 includes the retentive grooves 108. Though the example orthodontic appliance 100 depicted in FIG. 1 includes two retentive grooves 108, embodiments are not so limited. For example, the bonding surface 104 can include greater, or fewer, than two retentive grooves 108, as desired.

The retentive grooves 108 are cavities (e.g., channels) within the bonding surface 104. Accordingly, the retentive grooves 108 can receive bonding material as it is applied to the bonding surface 104 by, for example, a clinician. The retentive grooves 108 are nonlinear across the bonding surface 104. For example, as depicted in FIG. 1, the retentive grooves 108 include a number of linear sections that are joined at angles other than 180 degrees to form a “zig-zag” pattern across the bonding surface 104. It should be noted that in embodiments in which the bonding surface includes two or more retentive grooves 108, not all of the retentive grooves 108 need to be nonlinear across the bonding surface 104 or of the same shape, dimension, length, etc. Additionally, though the retentive grooves 108 depicted in FIG. 1 comprise multiple linear segments aligned to form a “zig-zag” pattern, embodiments are not so limited. For example, in some embodiments, the retentive grooves 108 can be curved across the bonding surface 104.

In some embodiments, the retentive grooves 108 may span the entirety of the bonding surface 104 or only a portion of the bonding surface 104. For example, as depicted in FIG. 1, the retentive grooves 108 breach only one boundary (i.e., an occlusal boundary 112 in FIG. 1) of the bonding surface 104. In embodiments in which the retentive grooves 108 breach only one boundary of the bonding surface 104 (e.g., as depicted in FIG. 1), the retentive grooves 108 can breach any desired boundary of the bonding surface 104. For example, the retentive grooves 108 can breach the occlusal boundary 112 (i.e., as shown in FIG. 1), a gingival boundary, a mesial boundary, or a distal boundary of the bonding surface 104. A retentive groove 108 that breaches only one boundary of the bonding surface 104 may, in some embodiments, aid in removing excess bonding material that seeps from between the bonding surface 104 and a patient's tooth. Accordingly, it may be preferred, though not required, to the have the retentive grooves 108 breach the occlusal boundary 112 and/or the mesial boundary.

In embodiments in which the retentive grooves 108 breach two boundaries of the bonding surface 104, the retentive grooves 108 form a channel that spans the entirety of the bonding surface 104. In embodiments in which the retentive grooves 108 breach two boundaries of the bonding surface 104, any suitable boundaries of the bonding surface 104 can be breached. For example, the retentive grooves 108 can breach opposite boundaries (e.g., the mesial and distal boundaries or the occlusal boundary 112 and the gingival boundary). Alternatively, the retentive grooves 108 can breach adjacent boundaries of the bonding surface 104. For example, the retentive grooves 104 can breach the occlusal boundary 112 and the distal boundary, the occlusal boundary 112 and the mesial boundary, the gingival boundary and the distal boundary, or the gingival boundary and the mesial boundary.

While the above discussion provides detail regarding retentive grooves 108 that breach either one or two boundaries of the bonding surface 104, embodiments are not so limited. For example, in some embodiments, the retentive grooves 108 may be fully contained within the bonding surface 104 (i.e., not breach any of the boundaries of the bonding surface 104, such as those depicted in FIGS. 5A-5C). In such embodiments, the retentive grooves 108 may be elongated (as described with respect to FIG. 1) and/or markers (as described with respect to FIGS. 4 and 5). Alternatively, the retentive grooves 108 may breach more than two boundaries of the bonding surface 104 (e.g., three boundaries, four boundaries, etc.). In embodiments in which the retentive grooves 108 breach more than two boundaries of the bonding surface 104, the retentive grooves 108 can breach any desired boundaries (e.g., the occlusal boundary 112, the distal boundary, and the mesial boundary, or any other combination of boundaries of the bonding surface 104). Further, in some embodiments, each of the retentive grooves 108 need not breach the same boundary or boundaries. For example, one of the retentive grooves 108 may breach the occlusal boundary 112 and a second of the retentive grooves 108 may breach the distal boundary. Similarly, all of the retentive grooves 108 need not breach the same number of boundaries of the bonding surface 104. For example, one of the retentive grooves 108 may breach only one boundary of the bonding surface 104 while a second of the retentive grooves 108 may breach greater than one of the boundaries (or none of the boundaries) of the bonding surface 104. In some embodiments, the bonding surface 104 includes a curvature in at least one plane, for example, as described in U.S. patent applicant Ser. No. 16/875,618, titled SYSTEMS AND METHODS FOR MANUFACTURE OF ORTHODONTIC APPLIANCES filed May 15, 2020 and incorporated herein by reference in its entirety. In such embodiments, the retentive grooves 108 can follow the curvature of the bonding surface 104. Additionally, as depicted in FIG. 1, the retentive grooves 108 can include dovetails. That is, walls of the retentive grooves 108 can be angled such that bases of the retentive grooves 108 (i.e., the portion of the retentive grooves 108 furthest from the bonding surface 104) can be wider than openings of the retentive grooves 108 (i.e., the portion of the retentive grooves 108 flush or nearly flush with the bonding surface 104).

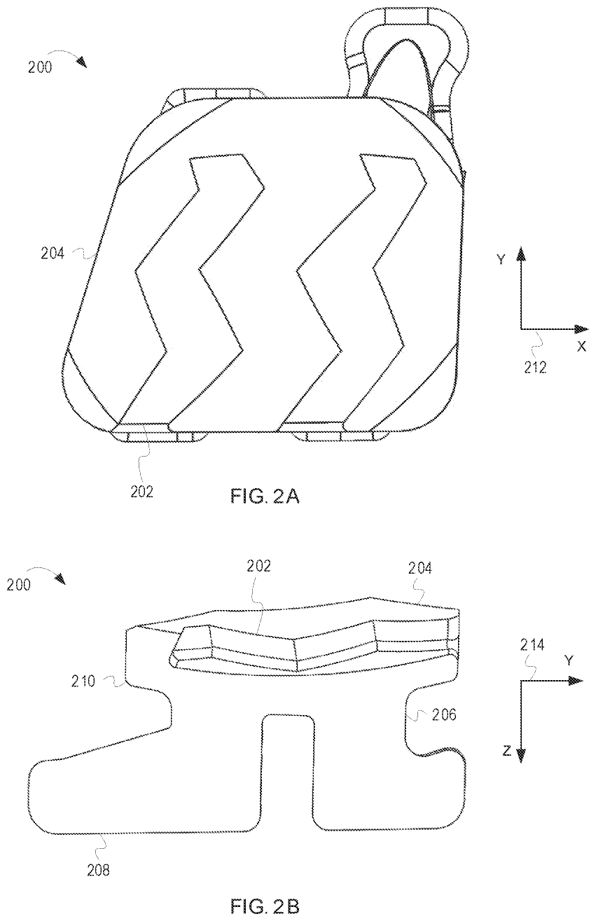

While the discussion of FIG. 1 provides an overview of an orthodontic appliance including negatively extruded retentive grooves, the discussion of FIGS. 2A-2B provides additional detail regarding such orthodontic appliances.

FIGS. 2A and 2B are top and sectional views, respectively, of an orthodontic appliance 200 including retentive grooves 202 in a bonding surface 204 of the orthodontic appliance 200, according to some embodiments. The orthodontic appliance 200 includes a body 206 (including a bonding pad 210), a facial surface 208, and the bonding surface 204. The bonding surface 204 includes the retentive grooves 202. The retentive grooves 202 are nonlinear across the bonding surface 204. As previously discussed, in some embodiments, the bonding surface 204 includes a curvature in at least one plane. For example, as depicted in FIG. 2B, the bonding surface 204 is concave with respect to the body 206 of the orthodontic appliance 200 and curves in a Z direction, as indicated by a second coordinate reference 214. In such embodiments, the retentive grooves 202 can follow or approximate the curvature of the bonding surface 204. In embodiments in which the retentive grooves 202 follow or approximate the curvature of the bonding surface 204, the retentive grooves 202 are curved in that they follow or approximate the curvature of the bonding surface 104.

As described herein, in some embodiments, the retentive grooves 202 are nonlinear across the bonding surface 204, regardless of any possible curvature that follows or approximates a curvature of the bonding surface 204. The retentive grooves 202 are nonlinear across the bonding surface 204 in that they are nonlinear in an X-Y plane, as indicated by a first coordinate reference 212. That is, the retentive grooves 108 are nonlinear when viewing the bonding surface 104 from above (e.g., as depicted in FIG. 2A).

The retentive grooves 202 can be nonlinear across the bonding surface 204 in any suitable fashion. For example, the retentive grooves can be nonlinear in a mesial-distal direction and/or in an occlusal-gingival direction. The retentive grooves 202 are nonlinear in that they include multiple linear segments and/or at least one curved segment across the bonding surface 204. The linear segments are linear in that they are a linear cut along a curved path, for example, that follows the curvature of the bonding surface 204. Accordingly, the linear segments may feature a curvature due to the curvature of the bonding surface, though they are linear features within the curved surface, as can be seen in FIG. 2B with respect to the X-Y plane.

In some embodiments, such curvature of the bonding surface 204 and retentive grooves 202 allows the bonding pad 210 to have a uniform, or nearly uniform, thickness. For example, as can be seen in the sectional view of FIG. 2B, the bonding pad 210 has a nearly uniform thickness across the bonding surface 204. The retentive grooves 202 are formed (e.g., during additive manufacture of the orthodontic appliance 200) in the bonding surface 204 and follow the curvature of the bonding surface 204. Accordingly, in embodiments in which the retentive grooves 202 feature linear segments, the linear segments are linear in the X-Y plane though they may be curved in the Y-Z plane and/or X-Z plane.

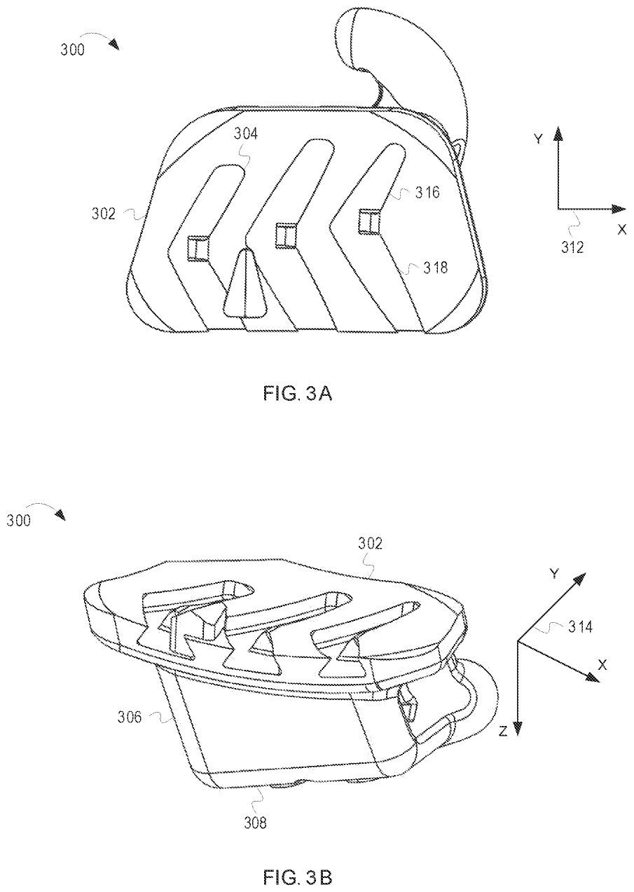

While the discussion of FIGS. 1 and 2A-2B describe an orthodontic appliance including retentive grooves featuring a “zig-zag” pattern, FIGS. 3A-3B depict an orthodontic appliance including retentive grooves featuring two linear segments.

FIGS. 3A and 3B are top and isometric views, respectively, of an orthodontic appliance 300 including retentive grooves 304 in a bonding surface 302 of the orthodontic appliance 300, according to some embodiments. The orthodontic appliance 300 includes a body 306, a facial surface 308, and the bonding surface 302. The bonding surface 302 includes the retentive grooves 304. The retentive grooves 304 are nonlinear across the bonding surface 302. That is, the retentive grooves 304 are nonlinear an X-Y plane, as indicated by a first coordinate reference 312. Each of the retentive grooves 304 is formed from two linear segments: first linear segments 316 and second linear segments 318. The first linear segments 316 and the second linear segments 318 are at least partially linear in the X-Y plane, and form the nonlinear retentive grooves 304.

As previously discussed, in some embodiments, the bonding surface 302 is curved. For example, as depicted in FIG. 3B, the bonding surface features a curvature in a Z axis, as indicated by a second coordinate reference 314. The curvature of the bonding surface 302 can be in the X-Z plane and/or the Y-Z plane. In some embodiments, the retentive grooves 304 follow the curvature of the bonding surface 302. In such embodiments, the first linear segments 316 and second linear segments 318 are linear in the X-Y plane but may not be linear in the X-Z plane and/or Y-Z plane.

While the discussion of FIGS. 1, 2A-2B, and 3A-3B describes orthodontic appliances including elongated retentive grooves, the discussion of FIGS. 4A-4C and 5A-5C describes orthodontic appliances including negatively extruded retentive grooves that function as markers.

FIGS. 4A-4C depict orthodontic appliances 400 including markers 410 in a bonding surface 402 of the orthodontic appliance 400, according to some embodiments. The orthodontic appliances 400 include a body, a facial surface, and a bonding surface 402. As depicted in FIGS. 4A-4C, the markers are negatively extruded (i.e., the markers 410 extend into the body of the orthodontic appliance 400 from the bonding surface 402). Because the markers 410 are negatively extruded into the body of the orthodontic appliance, the markers 410 can act as retentive grooves. Accordingly, the markers 410 can be referred to as retentive grooves. The markers 410 indicate a position for the orthodontic appliance 400 in a patient's mouth. For example, the markers 410 can indicate a tooth to which the orthodontic appliance 400 should be bonded and/or a jaw of the patient (i.e., the upper or lower jaw). The orthodontic appliance 400 can include any desired number of markers 410. The markers 410 can be arranged in any desired manner. The markers 410 can indicate a position of the orthodontic appliance 400 using any suitable convention or scheme, such as those described in U.S. patent application Ser. No. 17/011,071, titled SYSTEMS AND METHODS FOR MARKING ORTHODONTIC DEVICES filed Sep. 3, 2020 and incorporated herein by reference in its entirety. It should be understood that the disclosure of markers contained in U.S. patent application Ser. No. 17/011,071 can be incorporated with the disclosure provided herein. While the example orthodontic appliances 400 include negatively extruded markers 410 in the bonding surface 402, embodiments are not so limited. For example, the orthodontic appliances 400 can include such markers 410 (i.e., negatively extruded markers 410) in any suitable surface (e.g., a facial surface, side, etc. of the orthodontic appliance 400).

The markers 410 can be of different types. For example, the markers 410 can be of a first type (e.g., round, such as the markers 410) and a second type (e.g., oblong, such as the marker 410A). Though depicted as round and oblong in FIGS. 4A-4C, it should be noted that the types of markers 410 can be defined by any suitable feature (e.g., shape, size, depth, color, location, etc.). For example, in one embodiment, the markers 410 can include alphanumeric characters and/or polygonal shapes. In some embodiments, different types of markers can indicate different types of information. For example, the first type or marker 410 (and, for example, the number and/or location of the first type of marker 410) can indicate a tooth within the patient's mouth and the second type of marker 410A (and, for example, the number and/or location of the first type of marker 410A) can indicate a jaw within the patient's mouth.

In some embodiments, the orthodontic appliance 400 can include additional retentive grooves 408 (e.g., elongated retentive grooves, such as those depicted in FIG. 1). The additional retentive grooves 408 can be linear and/or nonlinear. In such embodiments, the markers 410 can be located outside of the retentive grooves 408, as depicted in FIGS. 4A-4C. However, such is not required and, in some embodiments, one or more of the markers 410 can be located partially, or fully, within one or more of the retentive grooves 408.

In some embodiments, the bonding surface 402 of the orthodontic appliance can be curved (e.g., as depicted in, and described with reference to, FIGS. 2A-2B and 3A-3B). Because the markers 410 are negatively extruded into the bonding surface 402, in some embodiments, the markers 410 can follow the curvature of the bonding surface 402.

As previously discussed, in some embodiments, the markers 410 are negatively extruded into the bonding surface 402 of the orthodontic appliance. Because the markers 410 are negatively extruded into the bonding surface 402 of the orthodontic appliance 400, the markers 410 are part of the structure of the orthodontic appliance 400. In such embodiments, the markers 410 can act as retentive grooves, such as those described with respect to FIGS. 1-3. Accordingly, the markers 410 can receive bonding material and act to retain the orthodontic appliance 400 on a patient's tooth.

FIGS. 5A, 5B, and 5C are top, isometric, and sectional views, respectively, of an orthodontic appliance 500 including negatively extruded retentive grooves 502 functioning as markers, according to some embodiments. The orthodontic appliance 500 includes a body 510, a bonding surface 504, and a facial surface 506. The bonding surface 504 includes the retentive grooves 502. In some embodiments, the retentive grooves 502 are negatively extruded into the bonding surface 504.

The retentive grooves 502 are nonlinear across the bonding surface 504 of the orthodontic appliance 500 and include both linear segments and curved segments. The retentive grooves 502 act as a marker in that the retentive grooves 502 indicate a position of the orthodontic appliance 500 in a patient's mouth. Accordingly, the retentive grooves 502 can take any suitable form and follow any desired marking convention or scheme. In the example depicted in FIGS. 5A-5C, the retentive grooves 502 are shaped to correspond to Palmer Notation, indicating a quadrant and tooth number with which the orthodontic appliance 500 is associated. Though the example orthodontic appliance 500 depicted in FIGS. 5A-5C include retentive grooves 502 that are shaped to correspond to Palmer Notation, embodiments are not so limited. That is, the retentive grooves 502 can be shaped in any manner suitable to indicate a position of the orthodontic appliance 500 in a patient's mouth.

In the example depicted in FIGS. 5A-5C, the retentive grooves 502 do not breach any of the boundaries of the bonding surface 504. That is, the retentive grooves 502 are fully contained within the bonding surface 504. This, however, is not required. For example, in some embodiments, some or all of the retentive grooves 502 may breach one or more boundaries of the bonding surface 504 of the orthodontic appliance 500 (e.g., as depicted in, and described with respect to, FIG. 1). Further, it should be noted that not all of the retentive grooves 502 need to function as markers. For example, the orthodontic appliance 500 can include retentive grooves 502 that function as markers as well as retentive grooves that may not function as markers, such as the elongated retentive grooves depicted in FIG. 1.

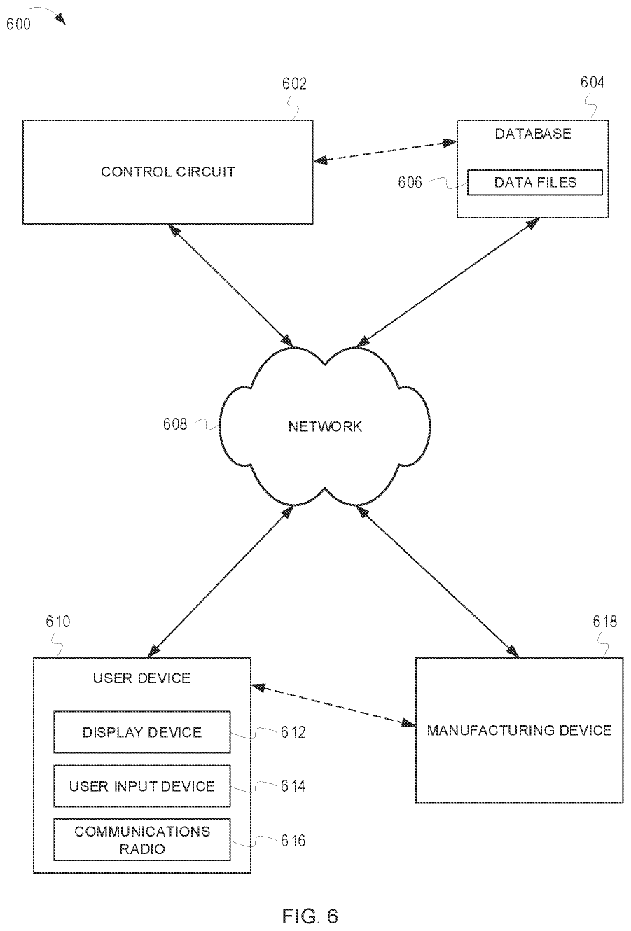

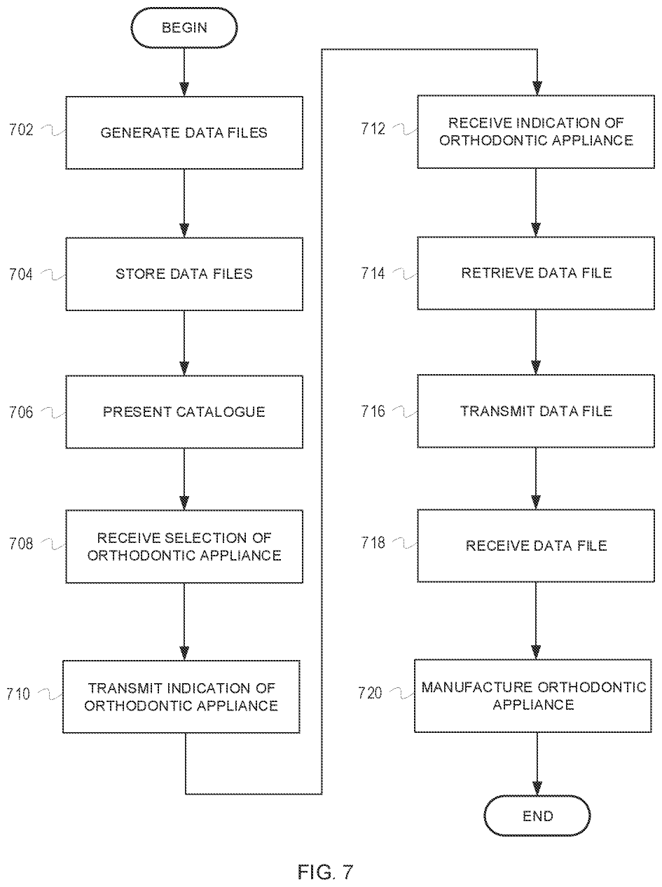

While the discussion of FIGS. 1-5 describes orthodontic appliances including negatively extruded retentive grooves, the discussion of FIGS. 6-7 provides additional detail regarding the manufacture of orthodontic appliances.

FIG. 6 is a block diagram of a system 600600 for providing data files associated with orthodontic appliances, according to some embodiments. The system 600 includes a control circuit 602, a database 604, a user device 610, and a manufacturing device 618. One or more of the control circuit 602, the database 604, the user device 610, and the manufacturing device 618 are communicatively coupled via a network 608. The network 608 can include a local area network (LAN) and/or wide area network (WAN), such as the internet. Accordingly, the network 608 can include wired and/or wireless links.

The user device 610 can be any suitable type of computing device (e.g., a desktop or laptop computer, smartphone, tablet, etc.). The user device 610 includes a display device 612. The display device 612 is configured to present a catalogue to a user. The catalogue includes orthodontic appliances that the user can obtain via the system 600. For example, the catalogue can include all orthodontic devices that the user can purchase and/or manufacture via the manufacturing device 618. The user interacts with the catalogue via a user input device 614. The user can interact with the catalogue by navigating the catalogue, making selections from the catalogue, modifying orthodontic appliances included in the catalogue, etc. Accordingly, the user input device 614 can be of any suitable type, such as a mouse, keyboard, trackpad, touchscreen, etc. The user device 610 also includes a communications radio 616. The communications radio 616 transmits and receives information for the user device 610. For example, in the case of a smartphone, the communications radio 616 can be a cellular radio operating in accordance with the 4G LTE standard. Once a user has made a selection of an orthodontic appliance, the user device 610, via the communications radio 616 and the network 608, transmits an indication of the selection to the control circuit 602.

The control circuit 602 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 602 is configured (for example, by using corresponding programming as will be well understood by those skilled in the art) to carry out one or more of the steps, actions, and/or functions described herein.

By one optional approach the control circuit 602 operably couples to a memory. The memory may be integral to the control circuit 602 or can be physically discrete (in whole or in part) from the control circuit 602 as desired. This memory can also be local with respect to the control circuit 602 (where, for example, both share a common circuit board, chassis, power supply, and/or housing) or can be partially or wholly remote with respect to the control circuit 602 (where, for example, the memory is physically located in another facility, metropolitan area, or even country as compared to the control circuit 602).

This memory can serve, for example, to non-transitorily store the computer instructions that, when executed by the control circuit 602, cause the control circuit 602 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit may be remote from the user device 610 and/or the manufacturing device 618. For example, the user device 610 and the manufacturing device 618 may be located in a clinician's office (e.g., the user's office) whereas the control circuit 602, and possibly the database 604, are cloud-based. The control circuit 602 generally operates to retrieve data files 606 based on the user's selection of orthodontic appliances. The control circuit 602 retrieves the data files 606 from the database 604. The database 604 is configured to store the data files 606. The data files 606 are associated with orthodontic appliances. The data files 606 are CAD files from which the orthodontic devices can be manufactured. The database 604 stores a data file for each of the orthodontic appliances included in the catalogue. In one embodiment, the database 604 stores a data file for all possible permutations of each orthodontic appliance (e.g., every possible modification and/or combination or modifications for each orthodontic appliance). The control circuit 602 receives the indication of the orthodontic appliance and retrieves a data file based on the indication of the orthodontic appliance.

It should be noted that the indication of the orthodontic appliance may include more than one orthodontic appliance. For example, the indication of the orthodontic appliance can include multiple orthodontic appliances, such as full set of brackets for a patient. Accordingly, the data file can be a file including instructions and/or specifications for multiple orthodontic appliances. For example, the data file may include multiple data files and/or multiple specifications for a number of brackets.

After retrieving the data file, the control circuit 602 transmits the data file. In some embodiments, the control circuit 602 encrypts or otherwise protects the data file before transmission. The control circuit 602 can encrypt or otherwise protect the data file before transmission to prevent those other than the user from accessing the data file. Additionally, in some embodiments, the control circuit 602 can encrypt or otherwise protect the data file to control the user's access to the data file. For example, in some embodiments, the system is set up such that user's pay on a per manufacture or per print basis. That is, the user does not purchase, and may not later have access to, the data file. Rather, the user purchases access to print or otherwise manufacture an orthodontic appliance based on the data file once (or other specified number of times).

Dependent upon the embodiment, the control circuit 602 transmits the data file to the user device 610, the manufacturing device 618, or a third-party device (e.g., a laboratory capable of manufacturing the orthodontic appliance for the user). To whom, or to what device, the data file is transmitted may also aid in achieving access control. For example, in one embodiment, the control circuit 602 transmits the data file directly to the manufacturing device 618. Because the data file is not transmitted to the user device 610, the data file may not be easily accessible by the user device 610. Further, if an entity that controls the control circuit 602 controls the manufacturing device 618, access may to files received by the manufacturing device 618 may be further limited. In some embodiments, the control circuit 602 transmits the data files to the user device 610. In such embodiments, the user device 610 transmits, via the communications radio (e.g., over a universal serial bus (USB) connection, wireless connection based on the 802.11 standard, etc.), the data files to the manufacturing device 618.

The manufacturing device 618 additively manufacturers the orthodontic appliance(s) based on the data file. The manufacturing device 618 can be of any suitable type, such as a 3D printer. The manufacturing device 618 can be local to, or remote from, one or more of the control circuit 602 and the user device 610. For example, in one embodiment, the user device 610 and the manufacturing device 618 are located in the user's office (i.e., the user device 610 and the manufacturing device 618 are local to one another). Alternatively, the manufacturing device 618 may be located in a laboratory or some other facility that manufactures orthodontic appliances for the user.

While the discussion of FIG. 6 provides additional detail regarding a system for providing data files associated with orthodontic appliances, the discussion of FIG. 7 describes example operations of such a system.

FIG. 7 is a flow chart including example operations for providing data files associated with orthodontic appliances, according to some embodiments. The flow begins at block 602.

At block 702, data files are generated. For example, a human user and/or computer program can generate the data files. The data files are associated with orthodontic appliances. The data files are associated with orthodontic appliances such that the data files can be used to manufacture or otherwise produce orthodontic appliances based on the data files. In one embodiment, the data files are CAD files. The data files can be generated before, or at the time of, retrieval. The flow continues at block 704.

At block 704, the data files are stored. For example, a database can store the data files. The database can be of any suitable type and store the data files in any suitable manner. For example, the database can be a relational database, a NoSQL database, etc. The database stores the data files after they are generated. The flow continues at block 706.

At block 706, a catalogue is presented. For example, a user device can present the catalogue to a user. The catalogue includes orthodontic appliances that the user can purchase or otherwise obtain. The user can browse the catalogue and make selections via the user device. The flow continues at block 708.

At block 708, selection of an orthodontic appliance is received. For example, the user device can receive a selection of an orthodontic appliance. The selection of the orthodontic appliance can indicate which orthodontic appliance the user would like to manufacture and, in some embodiments, can also indicate modifications to the orthodontic appliance. For example, the catalogue can include a number of base orthodontic appliances. At least some of the base orthodontic appliances are modifiable by the user. The user selection can include an indication of the modifications. The flow continues at block 710.

At block 710, an indication of the orthodontic appliance is transmitted. For example, the user device can transmit an indication of the orthodontic appliance via a network. The indication of the orthodontic appliance indicates which orthodontic appliance(s) the user has chosen as well as any modifications to the orthodontic appliance(s). The flow continues at block 712.

At block 712, the indication of the orthodontic appliance is received. For example, a control circuit can receive the indication of the orthodontic appliance. The flow continues at block 714.

At block 714, a data file is retrieved. For example, the control circuit can retrieve the data file from the database. The data file is associated with the orthodontic appliance. That is, the data file includes the instructions and/or parameters necessary to manufacture the orthodontic appliance that the user has selected. In some embodiments, the control circuit can encrypt or otherwise protect the data file. As one example, the control circuit can encode the data file with single use encryption. The flow continues at block 716.

At block 716, the data file is transmitted. For example, the control circuit can transmit the data file. The control circuit can transmit the data file to the user device and/or a manufacturing device. The flow continues at block 718.

At block 718, the data file is received. For example, the data file can be received by the user device and/or the manufacturing device. If the data file is received by the user device, the user device transmits the data file to the manufacturing device. The flow continues at block 720.

At block 720, the orthodontic appliance is manufactured. For example, the manufacturing device can manufacture the orthodontic appliance. The manufacturing device can be of any type suitable to additively manufacture the orthodontic appliance. For example, the manufacturing device can be a 3D printer.

In some embodiments, an orthodontic appliance comprises a body, a facial surface, wherein the facial surface is located on a first side of the body, and a bonding surface, wherein the bonding surface is located on a second side of the body, wherein the bonding surface includes at least one retentive groove, and wherein the at least one retentive groove is nonlinear across the bonding surface.

In some embodiments, an orthodontic appliance comprises a body, a facial surface, wherein the facial surface is located on a first side of the body, and a bonding surface, wherein the bonding surface includes at least one negatively extruded marker, and wherein the at least one negatively extruded marker indicates a position for the orthodontic appliance in a patient's mouth.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

What is claimed is:

1. An orthodontic appliance, the orthodontic appliance comprising:
a body;
a facial surface, wherein the facial surface is located on a first side of the body;
a bonding surface, wherein the bonding surface is located on a second side of the body; and
a negatively extruded retentive groove formed in the bonding surface, wherein the negatively extruded retentive groove is nonlinear.

2. The orthodontic appliance of claim 1, wherein the negatively extruded retentive groove is a marker, wherein the marker indicates a position for the orthodontic appliance in a patient's mouth.

3. The orthodontic appliance of claim 1, wherein the negatively retentive groove includes a marker of a first type and marker of a second type, wherein the marker of the first type indicates a tooth within the patient's mouth and the marker of the second type indicates a jaw within the patient's mouth.

4. The orthodontic appliance of claim 2, further comprising:
a second retentive groove, wherein the second retentive groove is an elongated retentive groove.

5. The orthodontic appliance of claim 1, wherein the retentive groove includes one or more of linear segments and curved segments.

6. The orthodontic appliance of claim 1, wherein the bonding surface includes a curvature in at least one plane and wherein the at least one retentive groove follows the curvature of the bonding surface.

7. An orthodontic appliance, the orthodontic appliance comprising:
a body;
a facial surface, wherein the facial surface is located on a first side of the body; and
a bonding surface, wherein the bonding surface is located on a second side of the body, wherein the bonding surface includes at least one retentive groove, and wherein the at least one retentive groove is nonlinear across the bonding surface.

8. The orthodontic appliance of claim 7, wherein the at least one retentive groove includes at least two linear sections.

9. The orthodontic appliance of claim 1, wherein the at least one retentive groove is at least partially curved.

10. The orthodontic appliance of claim 7, wherein the bonding surface includes a curvature in at least one plane and wherein the at least one retentive groove follows the curvature of the bonding surface.

11. The orthodontic appliance of claim 7, wherein the at least one retentive groove includes dovetails.

12. The orthodontic appliance of claim 7, wherein the orthodontic appliance is a bracket.

13. The orthodontic appliance of claim 7, wherein the at least one retentive groove is negatively extruded into the bonding surface of the orthodontic appliance.

14. The orthodontic appliance of claim 7, wherein the at least one retentive groove is a marker, wherein the marker indicates a position for the orthodontic appliance in a patient's mouth.

15. The orthodontic appliance of claim 8, wherein the at least one retentive groove includes a marker and an elongated retentive groove.

16. An orthodontic appliance, the orthodontic appliance comprising:
a body;
a facial surface, wherein the facial surface is located on a first side of the body; and
a bonding surface, wherein the bonding surface includes at least one negatively extruded marker, wherein the at least one negatively extruded marker indicates a position for the orthodontic appliance in a patient's mouth.

17. The orthodontic appliance of claim 16, wherein the at least one negatively extruded marker includes a marker of a first type and marker of a second type, wherein the marker of the first type indicates a tooth within the patient's mouth and the marker of the second type indicates a jaw within the patient's mouth.

18. The orthodontic appliance of claim 17, wherein the marker of the first type and the marker of the second type differ in one or more of shape, size, depth, color, and location.

19. The orthodontic appliance of claim 16, wherein the body includes at least one retentive grove, and wherein the at least one negatively extruded marker is located outside of the at least one retentive groove.

20. The orthodontic appliance of claim 16, wherein one or more of a number of the at least one negatively extruded marker and a location of the at least one negatively extruded marker indicate the position of the orthodontic appliance in the patient's mouth.
